(19) United States
(12) Patent Application Publication
(10) Pub. No.: US 2014/0343855 A1
(43) Pub. Date: Nov. 20, 2014

(54) Drought Monitoring and Prediction Tools

(71) Applicant: THE REGENTS OF THE UNIVERSITY OF CALIFORNIA, Oalkand, CA (US)

(72) Inventors: Amir AghaKouchak, Irvine, CA (US); Zengchao Hao, Norman, OK (US); Navid Nakhjiri, Beverly Hills, CA (US)

(21) Appl. No.: 14/278,525

(22) Filed: May 15, 2014

Related U.S. Application Data
(60) Provisional application No. 61/823,491, filed on May 15, 2013.

(51) Int. Cl. G01W 1/10

(52) U.S. Cl. CPC G01W 1/10
USPC 702/3

(57) ABSTRACT

Novel methods of deriving multivariate drought indicators are provided, these novel indices being indicators of both drought onset and persistence. Also described herein is a suite of tools and methods for drought monitoring and prediction. These tools provide probability of drought occurrence for a given region using a combination of near past and historical variables.

### CROSS-REFERENCE TO RELATED APPLICATIONS

This application is based on and claims the benefit of priority of U.S. Provisional Patent Application Ser. No. 61/823,491 filed on May 15, the contents of which are hereby incorporated by reference.

### STATEMENT REGARDING FEDERALLY SPONSORED RESEARCH OR DEVELOPMENT

This invention was made in part using funding provided by the National Science Foundation, Award No. IIP-1354546. The United States Government has certain rights in the invention.

### REFERENCE TO SEQUENCE LISTING, A TABLE, OR A COMPUTER PROGRAM LISTING COMPACT DISK APPENDIX

Not Applicable

### BACKGROUND AND SUMMARY OF THE INVENTION

Drought is among the most costly natural disasters in the world with tremendous losses in the order of billions of dollars and, in some cases, famine. A drought early warning system with forecasts of onset, severity, persistence, and spatial extent in a timely manner would provide invaluable information for drought mitigation.

Drought forecasting is generally based on a certain drought indicator (e.g., precipitation) forecasted for the next month/season/year. Yoon et al. [2012] employed the precipitation seasonal forecast for the meteorological drought prediction over the United States based on the standardized precipitation index (SPI). Lyon et al. [2012] proposed the baseline probability method for drought forecasting based on the persistence of SPI, which is compared with the dynamic climate model for assessing the U.S. seasonal drought predictions [Quan et al., 2012]. However, precipitation is highly variable in space and time and is difficult to predict even at seasonal scales. For this reason, prior art drought prediction models that are based on precipitation forecasts are not accurate and are subject to high uncertainty.

Described herein is a suite of tools and methods for drought monitoring and prediction. These tools provide probability of drought occurrence, and can potentially be used in a wide variety of applications including investment decision making, agricultural planning, and water resources management.

### DETAILED DESCRIPTION OF THE INVENTION

A first element utilized in the methods of the invention is use of multiple input data sets for composite drought assessment. “Input data” comprises measurements and estimates of meteorological and soil moisture parameters from different sources. Exemplary types of input data include measures and estimates of precipitation, temperature, evaporative demand, soil moisture content, water vapor, relative humidity, runoff, etc.

The methods of the invention are directed to novel indicators and methods of using such indicators in drought monitoring and prediction. The input data are used to derive indicators. “Indicators,” as used herein, refer to variables which indicate some aspect of hydrological, soil, or agricultural status of a region of interest. For example, a precipitation indicator is directed to rainfall/snowfall in the zone of interest. A soil moisture indicator is directed to the amount of moisture in the soil in the zone of interest. Indicators may comprise indices. Indices, as known in the art, can distill variables into numerical scores for ease of use and comparison. Exemplary indicators comprising indices include SPI (Standard Precipitation Index). An “indicator value” refers to the numeric value of a given indicator at a specific point in time or time interval, for a specific region.

Drought monitoring is typically based on one or more drought indicators. Monitoring is aided by the assignment of drought thresholds, which define various hydrological states. For example, a drought indicator value below a certain threshold may be said to define a “drought condition,” or a “severe drought condition,” while an indicator value above a certain threshold may define “a lack of drought condition.” Thresholds may be assigned arbitrarily, or may be tied to specific meteorological, agricultural, or other variables associated with the threshold. For example, an indicator value below which crop performance is negatively affected can be assigned as a threshold defining a “drought” state. This invention offers the opportunity to combine multiple data sets into a composite indicator for a more comprehensive drought assessment.

In another aspect, the invention is directed to drought prediction. The drought prediction tools described herein comprise novel statistical analysis methods for predicting probability of drought occurrence.

The drought prediction component is an integrated software tool which can acquire and manage input data, calculate indicator values, and provide drought monitoring and prediction information based on multiple indicators.

In light of the above definitions, the various embodiments of the invention will be described in greater detail.

Input Data.

Input data include meteorological measurements and estimates, soil moisture measurements and estimates, and other measures which may be utilized to calculate an indicator. In one embodiment, the input data sources include precipitation and soil moisture data such as that from the NASA Modern-Era Retrospective analysis for Research and Applications (MERRA-Land; Reichle et al., 2011, 2012), North American Land Data Assimilation System (NLDAS; Kumar et al., 2006), Global Land Data Assimilation System (GLDAS; Kumar et al., 2006) and the Global Drought Climate Data Record (AghaKouchak and Nakhjiri, 2012).

Indicators.

Various indicators may be used in the practice of the invention. For example, meteorological indicators such as the well-known Standard precipitation index (SPI) may be used, as well as other precipitation based indices known in the art.

SSI.

The invention encompasses the use of the Standardized Soil Moisture Index (SSI; Hao and AghaKouchak, 2014). SSI, is a standardized index of soil moisture estimates or measurements. SSI may be calculated as follows. Rather than utilizing a parametric approach to define the index, as is typically done for calculating SPI, SSI as employed in the invention is derived using an empirical approach. In one implementation, SSI is a nonparametric standardized index. The marginal probability of soil moisture may be derived, for example, using the empirical Gringorten plotting position (Gringorten (1963)):

$$P ( {x}_{i} ) = \frac{i - 0.44}{n + 0.12} \qquad EQUATION 1$$

where, n is the sample size, i denotes the rank of non-zero precipitation data from the smallest, and p(xᵢ) is the corresponding empirical probability. The outputs of Equation 1 can be transformed into a Standardized Index (SI) as:

SI=φ⁻¹(p) EQUATION 2

where φ is the standard normal distribution function, and p is probability derived from Equation 1. One can also standardize the percentiles using the following commonly-used approximation (Abramowitz and Stegun (1965); Naresh Kumar et al. (2009); Edwards (1997b)):

$$SI = \{ \begin{matrix}- ( t - \frac{{C}_{0} + {C}_{1} t + {C}_{2} {t}^{2}}{1 + {d}_{1} t + {d}_{2} {t}^{2} + {d}_{3} {t}^{3}} ) & if 0 < p \leq 0.5 \\ + ( t - \frac{{C}_{0} + {C}_{1} t + {C}_{2} {t}^{2}}{1 + {d}_{1} t + {d}_{2} {t}^{2} + {d}_{3} {t}^{3}} ) & if 0.5 < p \leq 1\end{matrix} \qquad EQUATION 3$$

where c0=2.515517; c1=0.802583; c2=0.010328; d1=1.432788; d2=0.189269; d3=0.001308; and

$$t = \{ \begin{matrix}\sqrt{ln \frac{1}{{p}^{2}}} \\ \sqrt{ln \frac{1}{{( 1 - p )}^{2}}}\end{matrix} \qquad EQUATION 4$$

This approach may be applied to other variables, such as precipitation, relative humidity, evaporative demand, water vapor, etc. Additionally, other probability plotting functions known in the art, such as the Adamowski, Beard, Blom, Chegodayev, Cunnane, Hazen, Hirsch, IEC56, Landwehr, Laplace, Mc Clung, Tukey, Filliben estimator, Weibull, Gumbel and Anon methodologies may be employed.

Composite Indicators.

A composite indicator is an indicator that synthesizes multiple variables into a single multivariate indicator. Exemplary composite indicators include the Palmer drought index (PDI); the Standardized Precipitation Evapotranspiration Index (SPEI), and the Vegetation Drought Response Index, etc., as known in the art.

A meteorological drought (deficit in precipitation) may develop quickly and end abruptly, while the onset of an agricultural drought (deficit in soil moisture) responds to a meteorological drought with some time lag [Heim, 2002]. Meanwhile, soil moisture plays an important role in the drought persistence [Seager et al., 2005]. These findings imply that precipitation deficit is suitable for detecting drought onset, while the soil moisture deficit is a better choice for capturing drought persistence. Using precipitation data alone is a poor predictor of drought persistence while utilization of soil moisture data alone may not accurately predict drought onset. Accordingly, the invention comprises the use of a composite indicator based on the joint distributions of precipitation and soil moisture to derive an indicator which captures both drought onset and persistence.

In one embodiment, the invention comprises a novel composite indicator, based on the joint distribution of precipitation and soil moisture. In another embodiment, a composite indicator based on the joint distribution of precipitation and soil moisture comprises the Multivariate Standardized Drought Index (MSDI) which combines drought information from precipitation (meteorological droughts) and soil moisture (agricultural droughts) in a probabilistic manner, as described below. Advantageously, utilizing the novel MSDI of the invention as an indicator provides a measure of drought status that captures both drought onset and persistence.

The Multivariate Standardized Drought Index (MSDI) is derived by determining the joint distribution of precipitation and soil moisture (e.g. SPI and SSI) for overall meteorological and agricultural drought characterization. The joint distribution of the precipitation (X) and soil moisture (Y) at a specific time scale (e.g., 6-month) can be expressed as:

P(X≦x,Y≦y)=p EQUATION 5

The MSDI can then be obtained by standardizing the joint probability p using the standard normal distribution function (φ):

MSDI=φ⁻¹(p) EQUATION 6:

MSDI can also be standardized using Equations 3 and 4. In one embodiment, as described in Hao and AghaKouchak, 2013, MSDI can be derived using multivariate parametric copulas, such as the Frank, Gumbel, or Clayton copulas, as known in the art. This methodology requires rigorous parameter estimation and goodness-of-fit tests. In an alternative embodiment, MSDI is derived using a non-parametric joint distribution concept to avoid making assumptions regarding the distribution family and to alleviate the computational burden in fitting parametric distributions. An empirical joint probability in the bivariate case can be estimated with the Gringorten plotting position formula as [Gringorten, 1963; Yue et al., 1999; Benestad and Haugen, 2007]:

$$P ( {x}_{k} , {y}_{k} ) = \frac{{m}_{k} - 0.44}{n + 0.12} \qquad EQUATION 7$$

In Equation 7, n is the number of the observation, and mₖ is the number of occurrences of the pair (xi, yi) for xᵢ≦xₖ and yᵢ≦yₖ (1≦i≦n). Once the joint probability (p) is derived from Equation 7, it will be used as input to Equation 6 in order to obtain the MSDI. Similar to the original SPI, a sequence of negative MSDIs indicates that the climate condition is dry (drought), while a sequence of positive MSDIs represents a wet climate condition. MSDI near zero refers to normal climate conditions.

Kao and Govindaraju 2010 first described the concept of using the joint cumulative probability as the overall drought indicator and proposed the joint deficit index based on the Kendall distribution. In the methods of the invention, the joint cumulative probability is used to construct the MSDI as an extension to the original SPI developed by McKee et al. 1993. In this implementation, MSDI advantageously bears a close resemblance to the SPI based on the fact that it can be used to monitor droughts at different time scales (e.g., 1-, 3-, 6-month).

Drought Monitoring.

For any given time scale, drought monitoring is accomplished by calculating the chosen drought indicator and determining which thresholds are met. In one embodiment, the model uses the threshold specified by the United States Drought Monitor (see Svoboda et al., 2002). However, different thresholds can be defined depending on user needs. Thresholds may be global or local, for example, depending on the local evaporative demand and/or crop water usage requirements in a specific region, a specific value of an indicator may be considered a drought condition in one region while being a non-drought condition in another region. It is within the skill of one in the art to define drought conditions for a specific region, as relevant to the water use needs of the region.

Drought Prediction.

Drought prediction is accomplished by predicting the indicator of interest for a particular time frame in the future and then determining whether it meets the thresholds defining drought and/or different degrees of drought.

In one embodiment, the invention comprises the use of any forecasting model which predicts an indicator based on the joint distribution of precipitation and soil moisture. In another embodiment, the predicted indicator based on the joint distribution of precipitation and soil moisture is MSDI. Other variables such as runoff, water vapor, and relative humidity can potentially be used as well.

In another embodiment, the invention comprises the use of the forecasting tools described below to predict the value of an indicator at a specific time point or within a specific time frame. In one implementation, the predicted indicator is SSI. In another implementation, the predicted indicator is MSDI. Similarly, the prediction can be based on other similar Standardized indicators (e.g., Standardized Relative Humidity Index).

Persistence Model.

The invention comprises the use of a persistence model to predict a drought indicator at a specified time or time range in the future (“future date”). The persistence model is an application of the ensemble mean concept. The ensemble used herein is a combination of currently-observed indicator values within a timeframe prior to future date (the “window”) and historical values for the indicator at the future date.

To illustrate, an example using a six month window is presented, wherein the indicator being predicted is soil moisture, wherein the timescale of the data is monthly. Soil moisture may be any indicator of drought, such as SSI or other indices or measures of soil moisture. “Accumulated soil moisture” (A) is defined as the sum of monthly soil moisture values within the window preceding the future date. For the month i: Aᵢ₌Sᵢ₋₅+ . . . Sᵢ, where Sᵢ₋₅, . . . , and Sᵢ, are the monthly soil moisture. We assume the l-month lead forecasting is needed based on the observation ended at month i. The l month (1≦l≦5) ahead forecasting for the month i+l based on the observation ended at month i can be expressed as a accumulated soil moisture Âᵢ₊₁

Âᵢ₊₁=Sᵢ₊ₗ₋₅+Sᵢ₊ₗ₋₄+Sᵢ₊ₗ₋₃+Sᵢ₊ₗ₋₂+Sᵢ₊ₗ₋₁+Sᵢ₊ₗ EQUATION 8

For example, for the one month lead forecasting (l=1), the forecasted value Âi₊₁, can be expressed as:

Âᵢ₊₁=Sᵢ₋₄+Sᵢ₋₃+Sᵢ₋₂+Sᵢ₋₁+Sᵢ+Sᵢ₊₁ EQUATION 9

where the Sᵢ₋₄, Sᵢ₋₃, Sᵢ₋₂, Sᵢ₋₁, and Sᵢ are the observed soil moisture and the Sᵢ₊₁ is unknown.

The Ensemble Streamflow Prediction (ESP) method, as known in the art, is used to predict the value of the target month by resampling the soil moisture from the historical observations, which is assumed to be an equally likely scenario in the future [Day, 1985; Lyon et al., 2012]. The prediction methodology generates an ensemble of m (e.g., the length of observation in the historical record) sequences of accumulated soil moisture (for l=1):

Aᵢ₊₁⁽¹⁾=Sᵢ₋₄+Sᵢ₋₃+Sᵢ₋₂+Sᵢ₋₁+Sᵢ+S⁽¹⁾ᵢ₊₁

Aᵢ₊₁⁽²⁾=Sᵢ₋₄+Sᵢ₋₃+Sᵢ₋₂+Sᵢ₋₁+Sᵢ+S⁽²⁾ᵢ₊₁

. . .

Aᵢ₊₁^{(m)}=Sᵢ₋₄+Sᵢ₋₃+Sᵢ₋₂+Sᵢ₋₁+Sᵢ+S^{(m)}ᵢ₊₁ EQUATION 10

where S⁽¹⁾ᵢ₊₁, . . . , S^{(m)}ᵢ₊₁ are the sequence of the randomly sampled monthly soil moisture from the observations in the historical record for the target month (here, i+1).

Each sequence of the blended 6-month soil moisture Aᵢ₊₁^{(j)}, j=1, 2, . . . m, can be combined with the observed 6 month accumulated soil moisture in the historical records and accordingly, the SSI for each sequence of the blended soil moisture can be obtained. Based on the ensemble of future SSI^{(j)}, j=1, 2, . . . m, a variety of ways can be used to display the final forecasting results. For example, this methodology is applied in Hao et al., 2014.

In one implementation, the ensemble mean is used as the final forecast result. This means that the month (1≦l≦5) ahead forecasted drought condition SSÎᵢ₊₁ based on the 6-month soil moisture can be obtained as:

$$SS {\hat{I}}_{i + l} = \frac{{\sum }_{j = 1}^{m} {SSI}^{( j )}}{m} \qquad EQUATION 11$$

In one implementation, the ensemble median is used as the final forecast result. In one implementation, the quantile corresponding to near past observations, e.g. of the initial conditions, relative to the long-term climatology is estimated and the same quantile is used instead of mean or median for prediction.

In addition, the probability that the soil moisture value falls below (or above) a certain threshold value (e.g., −0.5, −0.8) may be calculated:

P(SSI<−0.5)=(number of ensemble members that is below −0.5)/(total number of ensemble members). EQUATION 12

The probability values of the model may then converted to a 3-category drought likelihood measure, for example as follows:
(a) drought likely to persist (70% probability)
(b) drought very likely to persist (90% probability)
(c) drought extremely likely to persist (95% probability)

Alternatively, the outputs can be the probability of drought occurrence below a certain threshold (e.g., −0.5) for drought prediction.

It is understood that the basic methodology described above is illustrative and may be adapted to any drought indicator value. Variations of the basic methodology disclosed above may be practiced for the prediction of drought. For example, the six month soil moisture accumulation interval (window) utilized above may be shortened or lengthened, for example a 4-month or 7-month soil moisture accumulation window may be utilized, or, if historical soil moisture data is available on more granular time scales, fractions of months may be utilized. Various lead times (e.g. two months, three months, etc. may also be used. The basic methodology may be implemented for various windows and lead times, for example by generating an ensemble of the accumulated drought indicator values (A) as:

Aᵢ₊ₗₘ^{(1, . . . ,m)}=Σ_{w=1}^{w=nw}S_{i-w}+Σₗₘ₌₁^{lm=mlm}Aᵢ₊ₗₘ^{(1, . . . ,m)} EQUATION 13:

where S is the drought indicator value at each month in the near past or historical record, the time window (w) ranges from 1 to nw, and the lead month (lm) ranges from 1 to mlm with mlm<nm, and m is the number of years in the historical record.

For any methodology used to predict drought as described herein, alternative sampling or conditional sampling may be used for the prediction component. For example, one can sample from only from months in the historical data with similar large scale climatic conditions (e.g., El Niño-Southern Oscillation (ENSO), Pacific decadal oscillation (PDO) and North Atlantic Oscillation. (NAO)) which are matched to the climatic conditions the future date falls within.

It will be understood that the above soil moisture example may be extended to any indicator, including meteorological indicators, soil indicators, agricultural indicators, and composite indicators. For example, the methodology may be used to predict MSDI.

It will also be understood that any calculation of indicators and predictions within the conceptual framework of the disclosed equations is within the scope of the invention, and that various aspects of the equations may be modified to arrive at similar results.

### Example 1

In this example, the predictive methodology of the invention is demonstrated. Here, the one month lead prediction of SSI for the month of July 2013 (expressed as “2013-07” using the terminology of this example) is obtained. Historical data for the current season (2013) within the 6-month window prior to the target season are used to blend with the soil moisture of the target season 2013-07. Assume that monthly soil moisture data is available from January 1980 to June 2013, i.e. “1980-01” to “2013-06.” For the one month lead (L=1), the prediction of 6-month SSI for the target season 2013-07 can be expressed as:

A⁽¹⁾²⁰¹³₀₇=S²⁰¹³₀₂+S²⁰¹³₀₃+S²⁰¹³₀₄+S²⁰¹³₀₅+S²⁰¹³₀₆+S¹⁹⁸⁰₀₇

A⁽²⁾²⁰¹³₀₇=S²⁰¹³₀₂+S²⁰¹³₀₃+S²⁰¹³₀₄+S²⁰¹³₀₅+S²⁰¹³₀₆+S¹⁹⁸⁰₀₇

. . .

A⁽³³⁾²⁰¹³₀₇=S²⁰¹³₀₂+S²⁰¹³₀₃+S²⁰¹³₀₄+S²⁰¹³₀₅+S²⁰¹³₀₆+S¹⁹⁸⁰₀₇

Here S²⁰¹³₀₂, S²⁰¹³₀₃, S²⁰¹³₀₄, S²⁰¹³₀₅, S²⁰¹³₀₆ are the values for the current season (or year) 2013.

The predicted SSI value for the target season 2013-07 (or SSI²⁰¹³₀₇) is obtained from the predicted accumulated soil moisture for the target season 2013-07 (or A²⁰¹³₀₇). Each predicted A²⁰¹³₀₇ is combined with the historical accumulated soil moisture of the target month A¹⁹⁸⁰₀₇, . . . , A²⁰¹²₀₇ to obtain each predicted SSI²⁰¹³₀₇ The other monthly soil moisture within the 6-month window prior to the target season (or S²⁰¹³₀₂, S²⁰¹³₀₃, S²⁰¹³₀₄, S²⁰¹³₀₅, S²⁰¹³₀₆) is from the current season or year (2013) but not the historical mean. The predicted monthly soil moisture of the target season 2013-07 is essentially the historical data for the target season. In other words, there are 32 predicted monthly soil moisture values for the target season 2013-07 (S¹⁹⁸⁰₀₇, . . . , S²⁰¹¹₀₇, S²⁰¹²₀₇) There are 33 values of the “predicted” accumulated soil moisture A for the period 2013-07. For each value A^{(i) 2013}₀₇, it is combined with the historical values A¹⁹⁸⁰₀₇, A¹⁹⁸¹₀₇, . . . , A²⁰¹²₀₇ to get one predicted SSI value SSI⁽ⁱ⁾²⁰¹³₀₇. In total there are 33 predicted SSI values (or ensemble members).

For the two month lead for an August 2013 prediction, the observation of the current year (S²⁰¹³₀₃, S²⁰¹³₀₄, S²⁰¹³₀₅, S²⁰¹³₀₆) is blended with the monthly soil moisture for the target season (S¹⁹⁸⁰₀₇, . . . , or S²⁰¹²₀₇) and (S¹⁹⁸⁰₀₈, . . . , or S²⁰¹²₀₈) Note, here only one value from (S¹⁹⁸⁰₀₇, . . . , or S²⁰¹²₀₇) and one value from (S¹⁹⁸⁰₀₈, . . . , or S²⁰¹²₀₈) are sampled to represent the two month soil moisture prediction for the period 2013-07 and 2013-08.

Once an ensemble is defined, there are various ways the prediction results can be presented. Equation 13, with m=33 in our example, may be applied to yield the average predicted SSI in the target date. Or, the probability of drought occurrence persistence, embodied in an SSI below a certain threshold, can be determined by application of Equation 14.

### Example 2

In this Example, a system is described which includes the drought monitoring and prediction components, drought indicators (MSDI, SSI, etc) the system being called the Global Integrated Drought Monitoring and Prediction System (GIDMaPS). GIDMaPS is a drought monitoring and prediction system that provides near real-time drought information based on multiple drought indicators and input data sets. The software automatically downloads the input data sets discussed earlier and generates drought monitoring and prediction information as discussed above. The system is designed such that it can integrate more data and indicators in future.

The GIDMaPS system has been validated in a number of studies (Hao et al., 2014 and Hao and AghaKouchak, 2014). There is strong accord between the GIDMaPS data and that of the US Drought Monitor (USDM). Comparison of results generated at different locations and time frames show that GIDMaPS is consistent with the USDM data for two major events in 2007 and 2012 as described in Hao and AghaKouchak, 2014. It should be noted that the USDM data includes observations and inputs from many variables including subjective inputs from climatologists on the ground (human input) that cannot be mathematically accounted for. Also, the USDM does not provide forecasts and only shows the latest conditions based on observations. For this reason, GIDMaPS and USDM are not expected to be identical. Currently no other model similar to GIDMaPS exists for cross comparison.

In addition to prediction, the GIDMaPS offers drought monitoring based on multiple publically available data sets including the NASA Modern-Era Retrospective analysis for Research and Applications (MERRA-Land; Reichle et al., 2011, 2012), North American Land Data Assimilation System (NLDAS; Kumar et al., 2006), Global Land Data Assimilation System (GLDAS; Kumar et al., 2006) and the Global Drought Climate Data Record (AghaKouchak and Nakhjiri, 2012).

### Example 3

### A Multivariate Approach for Persistence-Based Drought Prediction

The Ensemble Streamflow Prediction (ESP) method, as known in the art, has been widely used for climate and hydrologic prediction. In this concept, the historical observations are assumed to be equally likely scenarios of the future. In previous studies, univariate indices such as precipitation and soil moisture percentile are used with the ESP concept for drought prediction. In the methods of the invention, a multivariate framework is proposed for applying the ESP to multiple variables (here, precipitation and soil moisture). The MSDI is then used for multi-index characterization of drought based on ESP-based predictions of precipitation and soil moisture. Assume that monthly precipitation and soil moisture data are available up to year n+1 (an n-year climatology is available for the study area). We define the target month m as the month for which drought conditions are to be predicted. In the following, the step-by-step process to derive 1-month lead drought prediction for the month m of year n+1 using the ESP and the 6-month MSDI is discussed. Denote the 6-month accumulated precipitation (AP) and soil moisture (AS) for target month m of year n+1 as AP_{n+1,m} and AS_{n+1,m}, which can be expressed as:

AP_{n+1,m}=P_{n+1,m-5}+P_{n+1,m-4}+P_{n+1,m-3}+P_{n+1,m-2}+P_{n+1,m-1}+P_{n+1,m} EQUATION 15

and

AS_{n+1,m}=S_{n+1,m-5}+S_{n+1,m-4}+S_{n+1,m-3}+S_{n+1,m-2}+S_{n+1,m-1}+S_{n+1,m} EQUATION 16

where P_{n+1,m} and S_{n+1,m} are precipitation and soil moisture to be predicted for the target month m, respectively. In the above equation, the accumulations (P_{n+1,m-1}, P_{n+1,m-2}, P_{n+1,m-3}, P_{n+1,m-4}, P_{n+1,m-5}) and (S_{n+1,m-1}, S_{n+1,m-2}, S_{n+1,m-3}, S_{n+1,m-4}, S_{n+1,m-5}) are termed as the initial conditions for predicting AP_{n+1,m} and AS_{n+1,m} (precipitation and soil moisture in the target month). Given that the objective of this method is seasonal drought prediction, the 6-month time scale is used for drought prediction. This means that in Equation (2), 1-month lead drought is predicted based on the past five months of initial condition. It should be noted that for prediction in January of year n+1, the initial conditions will be sampled from year n.

Based on the ESP method, the predictions of P_{n+1,m} and S_{n+1,m} in Equation 14 and Equation 15 can be obtained from the historical records (n-year climatology). Similarly, for a 2-month lead prediction for the target month m, the accumulated precipitation (AP) and soil moisture (AS) can be expressed as:

AP_{n+1,m}=P_{n+1,m-5}+P_{n+1,m-4}+P_{n+1,m-3}+P_{n+1,m-2}+P_{n+1,m-1}+P_{n+1,m} EQUATION 17

and

AS_{n+1,m}=S_{n+1,m-5}+S_{n+1,m-4}+S_{n+1,m-3}+S_{n+1,m-2}+S_{n+1,m-1}+S_{n+1,m} EQUATION 18

In this case, (P_{n+1,m-5}, P_{n+1,m-4}, P_{n+1,m-3}, P_{n+1,m-2}) and (S_{n+1,m-5}, S_{n+1,m-4}, S_{n+1,m-3}, S_{n+1,m-2}) are the initial conditions, while (P_{n+1,m}, P_{n+1,m-1}) and (S_{n+1,m}, S_{n+1,m-1}) are obtained from historical records (n-year climatology).

Based on Equation (2), n traces of accumulated precipitation and soil moisture from historical records can be derived as:

AP⁽ⁱ⁾_{n+1,m}=P_{n+1,m-5}+P_{n+1,m-4}+P_{n+1,m-3}+P_{n+1,m-2}+P_{n+1,m-1}+P_{i,m} EQUATION 19

and

AS⁽ⁱ⁾_{n+1,m}=S_{n+1,m-5}+S_{n+1,m-4}+S_{n+1,m-3}+S_{n+1,m-2}+S_{n+1,m-1}+S_{i,m} EQUATION 20

where i=1, . . . , n. For each combination AP⁽ⁱ⁾ₙ₊₁, and AS⁽ⁱ⁾_{n+1,m}, i=1, . . . , n, the MSDI⁽ⁱ⁾ can be computed based on the accumulated precipitation and soil moisture from historical records AP=(AP_{1,m}, . . . , AP_{n,m}) and AS=(AS_{1,m}, AS_{n,m}), respectively. For example, having the first trace of the predicted AP⁽¹⁾_{n+1,m} and AS⁽¹⁾_{n+1,m}, a new series can be constructed from the climatology of the target month m, i.e., (AP_{1,m}, . . . , AP_{n,m}, AP⁽¹⁾_{n+1,m}) and (AS_{1,m}, AS_{n,m}, AP⁽¹⁾_{n+1,m}). Then, the first predicted MSDI⁽¹⁾ for the target month m can be computed based on the joint probability of AP and AS:

MSDI⁽¹⁾=P(AP≦AP⁽¹⁾_{n+1,m},AS≦AS⁽¹⁾_{n+1,m}) EQUATION 21

From the observed precipitation and soil moisture in historical records (n years), the n-ensemble member of predicted MSDI (i.e., MSDI⁽¹⁾, MSDI⁽²⁾, . . . , MSDI⁽ⁿ⁾) can be obtained. The ensemble median is computed as a measure of the drought severity. Using this ensemble approach, one can estimate the probability of the MSDI below a certain threshold (e.g., −0.8, which indicates a moderate drought). Notice that the MSDI, similar to the SPI, is a standardized index in which a sequence of negative (positive) values represents a drought (wet) period. For example, the probability of the MSDI being less than −0.8 can be computed as the number of ensemble members that fall below −0.8 divided by the total number of ensemble members n. The probabilistic nature of this model allows the estimation of the risk (probability) of the predicted events. FIG. 1 summarizes the flowchart of the proposed modeling framework for drought prediction in target month m=8 (August) of year n+1.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

### LITERATURE CITED

AghaKouchak A., and Nakhjiri N., 2012, A Near Real-Time Satellite-Based Global Drought Climate Data Record, Environmental Research Letters, 7(4)
Andreadis, K. M., E. A. Clark, A. W. Wood, A. F. Hamlet and D. P. Lettenmaier (2005). Twentieth-century drought in the conterminous United States. Journal of Hydrometeorology. 6(6): 985-1001.
Day, G. N. (1985). Extended streamflow forecasting using NWSRFS. Journal of Water Resources Planning and Management. 111(2): 157-170.
Entin, J. K., A. Robock, K. Y. Vinnikov, S. E. Hollinger, S. Liu, et al. (2000). Temporal and spatial scales of observed soil moisture variations in the extratropics. Journal of Geophysical Research. 105(D9): 11865-11811,11877.
Gringorten, I. I. (1963). A Plotting Rule for Extreme Probability Paper. Journal of Geophysical Research. 68(3): 813-814.
Hao, Z. and A. AghaKouchak (2013). Multivariate Standardized Drought Index: A Multi-Index Parametric Approach for Drought Analysis. Advances in Water Resources, 57:12-18
Hao, Z. and A. AghaKouchak (2013b). A Multivariate Multi-Index Drought Monitoring Framework. Journal of Hydrometeorology. 15, 89-101
Hao, Z. et al. Global integrated drought monitoring and prediction system. Sci. Data 1:140001 doi: 10.1038/sdata.2014.1 (2014).
Heim, R. R. (2002). A review of twentieth-century drought indices used in the United States. Bulletin of the American Meteorological Society. 83(8): 1149-1166.
Koster, R. D., S. Mahanama, T. Yamada, G. Balsamo, A. Berg, et al. (2010). Contribution of land surface initialization to subseasonal forecast skill: First results from a multi-model experiment. Geophysical Research Letters. 37(2): L02402.
Kumar, S. V., and Coauthors, 2006: Land Information System: An interoperable framework for high resolution land surface modeling. Environ. Model. Software, 21, 1402-1415.
Lott, N. and T. Ross (2006). Tracking and evaluating US billion dollar weather disasters, 1980 Preprints. 86th AMS Annual Meeting, January 28-February 3, Atlanta, Ga.
Lyon, B., M. A. Bell, M. K. Tippett, A. Kumar, M. P. Hoerling, et al. (2012). Baseline probabilities for the seasonal prediction of meteorological drought. Journal of Applied Meteorology and Climatology. 51(7): 1222-1237.
McKee, T. B., N. J. Doesken and J. Kleist (1993). The relationship of drought frequency and duration to time scales. Eighth Conference on Applied Climatology, Am. Meteorol. Soc., Anaheim, Calif.
Quan, X. W., M. P. Hoerling, B. Lyon, A. Kumar, M. A. Bell, et al. (2012). Prospects for dynamical prediction of meteorological drought. Journal of Applied Meteorology and Climatology. 51(7): 1238-1252.
Quiring, S., J. Nielsen-Gammon, R. Srinivasan, T. Miller and B. Narasimhan (2007). Drought monitoring index for Texas. Texas Water Development Board: Austin, Tex.
Reichle, R. H. (2012). The MERRA-Land Data Product. http://gmao.gsfc.nasa.gov/research/merra/file_specifications/php
Reichle, R. H., R. D. Koster, G. J. De Lannoy, B. A. Forman, Q. Liu, et al. (2011). Assessment and enhancement of MERRA land surface hydrology estimates. Journal of climate. 24(24): 6322-6338.
Seager, R., Y. Kushnir, C. Herweijer, N. Naik and J. Velez (2005). Modeling of Tropical Forcing of Persistent Droughts and Pluvials over Western North America: 1856-2000. Journal of climate. 18(19): 4065-4088.
Seneviratne, S. I., R. D. Koster, Z. Guo, P. A. Dirmeyer, E. Kowalczyk, et al. (2006). Soil moisture memory in AGCM simulations: analysis of global land-atmosphere coupling experiment (GLACE) data. Journal of Hydrometeorology. 7(5): 1090-1112.
Sheffield, J. and E. F. Wood (2007). Characteristics of global and regional drought, 1950-2000: Analysis of soil moisture data from off-line simulation of the terrestrial hydrologic cycle. Journal of Geophysical Research. 112(D17): D17115.
Shukla, S., A. C. Steinemann and D. P. Lettenmaier (2011). Drought Monitoring for Washington State: Indicators and Applications. Journal of Hydrometeorology. 12(1): 66-83.
Yoon, J. H., K. Mo and E. F. Wood (2012). Dynamic-Model-Based Seasonal Prediction of Meteorological Drought over the Contiguous United States. Journal of Hydrometeorology. 13(2): 463-482.
Svoboda, Mark; Lecomte, Doug; Hayes, Mike; Heim, Richard; Gleason, Karin; Angel, Jim; Rippey, Brad; Tinker, Rich; Palecki, Mike; Stooksbury, David; Miskus, David; Stephens, Scott (2002). The drought monitor. Bulletin of the American Meteorological Society. 83: 1181-1190.

What is claimed is:

1. A method of calculating a composite standardized drought index, comprising plotting the joint probabilities of a meteorological variable and an agricultural variable; and standardizing the joint probability of the two variables.

2. The method of claim 1, wherein
the meteorological variable is selected from a group consisting of atmospheric variables such as precipitation, evaporative demand, water vapor, and relative humidity.

3. The method of claim 1, wherein
the agricultural variable is selected from a group consisting of land-surface variables such as soil moisture, groundwater, and total water storage.

4. The method of claim 1, wherein
the variables are selected from a group consisting of land-atmosphere variables, soil moisture, precipitation, evaporative demand, water vapor, and relative humidity.

5. The method of claim 1, wherein
the composite standardized drought index is standardized by application of the equation:
MSDI=φ¹(p)
where MSDI is the standardized composite index value, and p is the joint probability, and φ is the standard normal distribution function, and marginal probability.

6. A method of predicting the value of a composite drought indicator for a particular future date, comprising
generating an ensemble of values representing a combination of near past observed indicator values within a timeframe prior to the future date and long-term historical values for the same period to derive estimate of droughts at the future date using composite drought indicators; and
determining the probability of drought occurrence at the future date using the ensemble values.

7. The method of claim 6, wherein
the drought indicator is selected from the group consisting of SSI, MSDI, a meteorological indicator, an agricultural indicator, and a hydrological indicator.

8. The method of claim 6, wherein the drought indicator is either a univariate or multivariate drought indicator.

9. The method of claim 6, wherein, the ensemble is generated by
determining, for month i in year m+1, the six month accumulated drought indicator value (A) in the year n+1, as
Aᵢ₊₁^{(1 . . . m)}=Sᵢ₋₄+Sᵢ₋₃+Sᵢ₋₂+Sᵢ₋₁+Sᵢ+S^{(1 . . . m)}ᵢ₊₁
where S is the drought indicator at each month, S⁽¹⁾ᵢ₊₁, . . . , S^{(m)}ᵢ₊₁ are the sequence of the sampled monthly drought indicator variable from the observations in the historical record for the target month, and m is the number of years in the historical record.

10. The method of claim 6, wherein, the ensemble is generated as:
$${A}_{i + lm}^{( 1 , … , m )} = {\sum }_{w = 1}^{w = nw} {S}_{i - w} + {\sum }_{lm = 1}^{lm = mlm} {S}_{i + lm}^{( 1 , … , m )}$$
where S is the drought indicator value at each month in the near past or historical record, the time window (w) ranges from 1 to nw, and the lead month (lm) ranges from 1 to mlm with mlm<nm, and m is the number of years in the historical record.

11. The method of claim 6 wherein the ensemble value at the future date is calculated as the ensemble mean, ensemble median, or the quantile corresponding to near past observations (initial conditions).

12. The method of claim 6, wherein the probability that the value falls below a certain threshold is calculated as the total number of ensemble members that fall below the threshold divided by the total number of ensemble members.
